(19) United States
(12) Patent Application Publication
(10) Pub. No.: US 2022/0264007 A1
(43) Pub. Date: Aug. 18, 2022

(54) INTELLIGENT GIMBAL ASSEMBLY AND METHOD FOR UNMANNED VEHICLE

(71) Applicant: SKYYFISH LLC, Stevensville, MT (US)

(72) Inventor: Orest Jacob Pilskalns, Missoula, MT (US)

(21) Appl. No.: 17/734,021

(22) Filed: Apr. 30, 2022

Related U.S. Application Data
(63) Continuation-in-part of application No. 15/694,766, filed on Sep. 2, 2017.
(60) Provisional application No. 62/383,354, filed on Sep. 2, 2016.

(51) Int. Cl. H04N 5/232; H04N 5/225; B64D 47/08; G08G 5/00; B64C 39/02

(52) U.S. Cl. CPC H04N 5/23258; H04N 5/23264; H04N 5/225251; H04N 5/2252; B64C 2201/141; G08G 5/003; G08G 5/0069; B64C 39/024; B64C 2201/127; B64D 47/08

(57) ABSTRACT

Simultaneous control of an unmanned vehicle and an on-board sensor is facilitated by the use of an intelligent gimbal assembly. The assembly includes a gimbal for carrying the sensor and a node controller for controlling the gimbal, sensor and the unmanned vehicle to which the gimbal assembly is attached. The node controller controls the flight or navigation controller of the unmanned vehicle via an application programming interface in the vehicle. The node controller can include drivers for controlling different vehicles and different gimbals.

### CROSS REFERENCE TO RELATED APPLICATIONS

The present application is a Continuation-In-Part of U.S. patent application Ser. No. 15/694,766, filed on Sep. 2, 2017, which claims the benefit of U.S. Provisional Application Ser. No. 62/383,354, filed on Sep. 2, 2016, all of which are herein incorporated by reference for completeness of disclosure.

### GOVERNMENT SUPPORT

This invention was made with government support under (grant/contract number) awarded by (institute, agency). The Government has certain rights in the invention.

### COPYRIGHT NOTICE

A portion of the disclosures of this patent document contains or may contain material that is subject to copyright protection. The copyright owner has no objection to the photocopy or electronic reproduction by anyone of the patent document or the patent disclosure in exactly the form it appears in the United States Patent and Trademark Office patent file or electronic records, but otherwise reserves all copyright rights whatsoever.

### TECHNICAL FIELD

This application relates to a gimbal assembly and method for controlling an unmanned vehicle. In particular, it relates to a gimbal assembly that provides an unmanned aerial vehicle (UAV) with additional computing power for controlling one or more of the UAV, the gimbal and/or one or more sensors on the UAV.

### BACKGROUND

The purpose of a gimbal is to hold a sensor or multiple sensors steady on a moving UAV or other craft. The gimbal is exposed to external influences such as vibrations induced by motors and environmental factors such as wind. The gimbal must be capable of using onboard computing to compensate for the vibrations or adjust for the weather. The gimbal must also aim the sensor at a feature on demand. The sensor collects data about the feature and/or its surroundings. The feature can be a point object, a linear object or an area.

Traditionally, gimbals on drones and full-scale craft are typically aimed or controlled by a human operator using a remote-control unit or a flight controller. The gimbal has no control over the flight controller. If no gimbal is present, then a sensor mounted on the UAV is in a fixed orientation relative to the UAV, and its pointing direction is determined by the pointing direction of the UAV.

A problem in the UAV industry is the difficulty in connecting sensors with flight controllers, data publication streams, and data analysis programs. Many people want custom applications for their own particular needs, whether it is for inspection, videography, security, search and rescue, 3D modeling via photogrammetry (i.e. the creation of point clouds from photographs and meta-data such as gimbal angles, GPS location and speed), or for an emerging field.

This background information is provided to reveal information believed by the applicant to be of possible relevance to the present invention. No admission is necessarily intended, nor should be construed, that any of the preceding information constitutes prior art against the present invention.

### SUMMARY

The system and method disclosed herein relate to a gimbal assembly and method for controlling an unmanned vehicle. In particular, the invention relates to a gimbal assembly that provides an unmanned aerial vehicle (UAV) with additional computing power for controlling the UAV, and/or the gimbal, and/or one or more sensors on the UAV.

A key feature of the gimbal assembly is a node controller that acts as a connection between several different types of UAV (crafts, drones, full scales, etc.) and several different sensors, which may not normally be connected directly to each other. The gimbal assembly allows the user to choose a UAV and a sensor independently from each other and then plan a mission without being limited to vertical solutions from a single vendor. Simultaneous control of a UAV and an on-board sensor is also facilitated by the use of the gimbal assembly. While described largely in relation to UAVs, the invention is also applicable to the control of other unmanned craft and their onboard sensors.

Disclosed herein is an assembly comprising: a gimbal; a sensor mounted on the gimbal; and a node controller mechanically connected to the gimbal, the node controller configured to control an unmanned vehicle; wherein the assembly is configured to be attached to and removed from the unmanned vehicle.

Also disclosed herein is a method for controlling an unmanned vehicle comprising: providing an assembly comprising: a gimbal; a sensor mounted on the gimbal; and a node controller mechanically connected to the gimbal, the node controller configured to control the unmanned vehicle; loading a navigation plan into the node controller; attaching the assembly to the unmanned vehicle; and navigating the unmanned vehicle under control of the node controller.

### BRIEF DESCRIPTION OF THE DRAWINGS

The following drawings illustrate embodiments of the invention, which should not be construed as restricting the scope of the invention in any way.

FIG. 1 is a schematic block diagram of a gimbal assembly connected to a UAV, according to an embodiment of the disclosed invention.

FIG. 2 is a gimbal assembly according to an embodiment of the disclosed invention.

FIG. 3 is a gimbal assembly according to an embodiment of the disclosed invention, connected to a UAV shown in partial view.

FIG. 4 is a schematic representation of the interrelations between the node controller and the other functions of a UAV that is carrying a gimbal assembly, according to an embodiment of the disclosed invention.

FIG. 5 is a schematic representation of the main functional blocks of the gimbal assembly and a UAV, according to an embodiment of the disclosed invention.

FIG. 6 is a schematic block diagram of a gimbal assembly connected to a UAV, according to a further embodiment of the disclosed invention.

FIG. 7 is a schematic block diagram of a gimbal assembly connected to a UAV, according to a still further embodiment of the disclosed invention.

FIG. 8 is a schematic block diagram of the node controller of a gimbal assembly, connected to a UAV without the gimbal, according to an embodiment of the disclosed invention.

FIG. 9 is a flowchart of a process carried out by the gimbal assembly according to an embodiment of the disclosed invention.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### DETAILED DESCRIPTION OF THE INVENTION

### A. Glossary

The term “gimbal” relates to a mechanism, typically consisting of rings pivoted at right angles, for keeping an instrument such as a sensor in a moving craft in a fixed orientation. The term may also be used to refer to a housing having such a mechanism.

The term “gimbal assembly” refers to an assembly of a node controller and a gimbal. A gimbal assembly may also be referred to as a smart gimbal. The gimbal assembly may also include one or more sensors.

The term “node controller” refers to the portion of the gimbal assembly that interfaces with both the gimbal and the UAV, and is able to control, for example, one or more aspects of the UAV and/or the gimbal. The node controller is detachable from the UAV, and may or may not be detachable from the gimbal. The node controller may also be referred to as a control module. Where the node controller can be detached from the gimbal, it can be used independently. For example, the node controller is used to control a UAV and a sensor, such as a fixed camera, Lidar, etc., without the sensor being mounted on a gimbal. In this case the node controller is an independent control module and the gimbal is a replaceable component that can be controlled by the node controller. However, it is often necessary to package the gimbal and the node controller together for various use-cases.

The term “remote controller” refers to the electronic user-computing device that a user uses to remotely control a UAV in real time.

The term “flight controller” or flight computer refers to an electronic control module located in a UAV, which is used for controlling the flight motors of the UAV and its landing gear.

The term “software” includes, but is not limited to, program code that performs the computations necessary for optimizing user inputs, performing and outputting calculations, controlling the UAV, controlling the gimbal, controlling the sensors, reporting and analyzing UAV specific data and sensor data, displaying information, and managing of input and output data.

The term “firmware” includes, but is not limited to, program code and data used to control and manage the interactions between the various modules of the system.

The term “hardware” includes, but is not limited to, the physical housing for a computer or device, as well as the display screen if any, connectors, wiring, circuit boards having one or more processor and memory units, power supply, and other electrical, electronic and mechanical components.

The term “module” can refer to any component in this invention and to any or all of the features of the invention without limitation. A module may be a software, firmware or hardware module, and may be located in the gimbal assembly, the UAV, a user device or a server.

The term “network” can include both a mobile network and data network without limiting the term's meaning, and includes the use of wireless (e.g. 2G, 3G, 4G, Wi-Fi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowchart, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “RTK” refers to Real-Time Kinetic in relation to a GPS (Global Positioning System) base station at or near a site of interest. An RTK GPS base station may be set up temporarily by a user or it may already be installed at the site. An RTK GPS base station corrects the determined location of a UAV in real time, if necessary. If there is a mismatch between the determined location and the corrected location, then the user can apply an offset to a flight plan before the flight is started.

### B. Overview

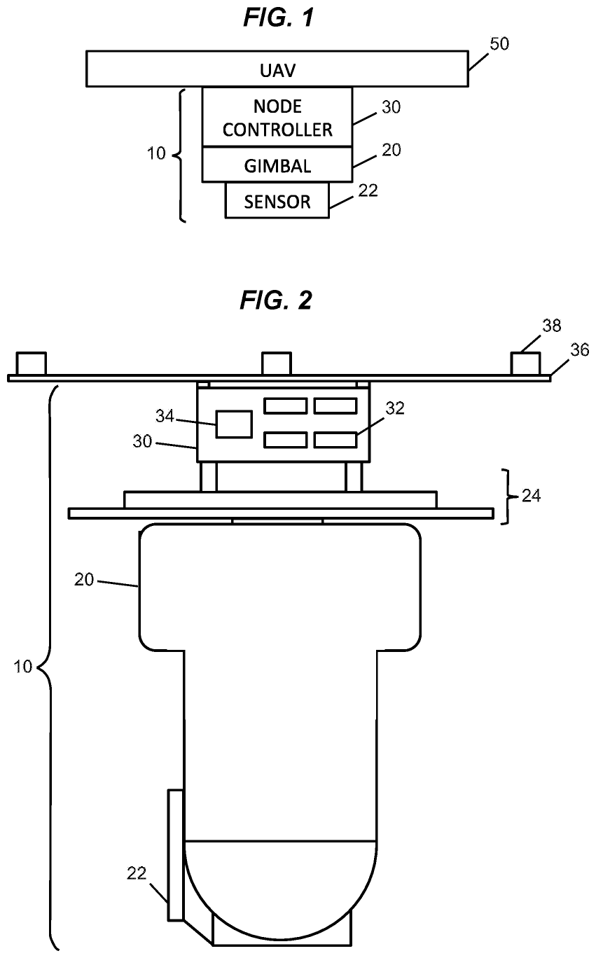

FIG. 1 shows a schematic block diagram of the main components of an exemplary embodiment of the gimbal assembly 10. The gimbal assembly 10 includes a gimbal 20, a sensor 22 and a node controller 30. The gimbal assembly 10 is mounted to a UAV 50. The sensor 22 is mounted onto the gimbal 20, the gimbal 20 is connected to the node controller 30, and the node controller is connected to the UAV 50. The node controller 30 controls one or more of the UAV 50, the gimbal 20 and the sensor 22. The gimbal assembly is detachable from the UAV 50 and can be attached to, and control, multiple different types of UAV.

### C. Exemplary Embodiment

FIG. 2 shows an exemplary gimbal assembly 10 with added intelligence for controlling the UAV to which it is to be attached. The gimbal assembly 10 includes a gimbal 20, which is able to carry a sensor 22. In this case the sensor 22 is a video camera, but other sensors can be carried instead, or as well. The rings of the gimbal mechanism are not visible as they are inside the housing of the gimbal 20. The gimbal 20 is connected via interface 24 to a node controller 30, which is also part of the gimbal assembly 10.

The node controller 30 can control the gimbal 20, or both the sensor 22 and the gimbal. By controlling the gimbal 20, the sensor, which is mounted on the gimbal, is indirectly controlled by the node controller 30. However, the sensor 22 may instead, or additionally, be directly controlled by the node controller 30, e.g. by being instructed to switch on and off

The interface 24 includes at least a mechanical interface for connecting the gimbal 20 to the node controller 30. The interface 24 may also include, depending on the embodiment, one or more electrical connectors for electrically connecting the gimbal 20 to the node controller 30. The node controller 30 includes one or more electrical interfaces or connectors, shown here as sockets 32, 34 for connecting to the UAV, the gimbal 20 and/or to devices external to the gimbal assembly 10. The sockets 32, 34 may also be used to connect the node controller 30 to devices external to and separate from the UAV to which the assembly is connected. The node controller 30 is suspended from a base 36, to which mechanical connectors 38 are attached for connecting to a UAV. The node controller 30 controls the UAV or other craft to which it is connected.

In some embodiments, the node controller 30 is detachable from the gimbal assembly 10 and can be used with other gimbals, provided that the other gimbals support the mechanical and electrical interfaces on the node controller. Likewise, the node controller 30 can control different types of UAV.

The node controller 30 that controls the UAV can also be clicked in and out of the base 36, allowing for quick assembly and disassembly, and modularity. This allows the various components of the gimbal assembly 10 to be manufactured, upgraded and replaced separately. Components that can be replaced include the gimbal 20, the sensor 22, the node controller 30, the interface 24 and the base 36, for example.

In other embodiments, the node controller 30 is placed next to or close to the sensor(s) 22. The most bandwidth-intensive communication path in some systems is between the sensors 22 and the node controller 30, particularly when the sensors are providing images, videos, etc. Placing the node controller 30 next to the sensors 22 minimizes the communication connections that need to travel through slip rings of the gimbal, which is a significant benefit. With this configuration, only the serial connections from the node controller 30 that control the UAV need to travel through the slip rings. This provides the advantage of being able to use smaller slip rings in the gimbal, which permits an order of magnitude smaller gimbal. A further advantage is a faster response time for real time data collection from the sensors 22.

The operating features of the gimbal assembly 10 are made possible using a single board computer inside the node controller 30. The single board computer is modified to provide the communication ports necessary (e.g. radio, USB, Ethernet, custom) for communicating with several different UAVs, several different gimbals and several different sensors.

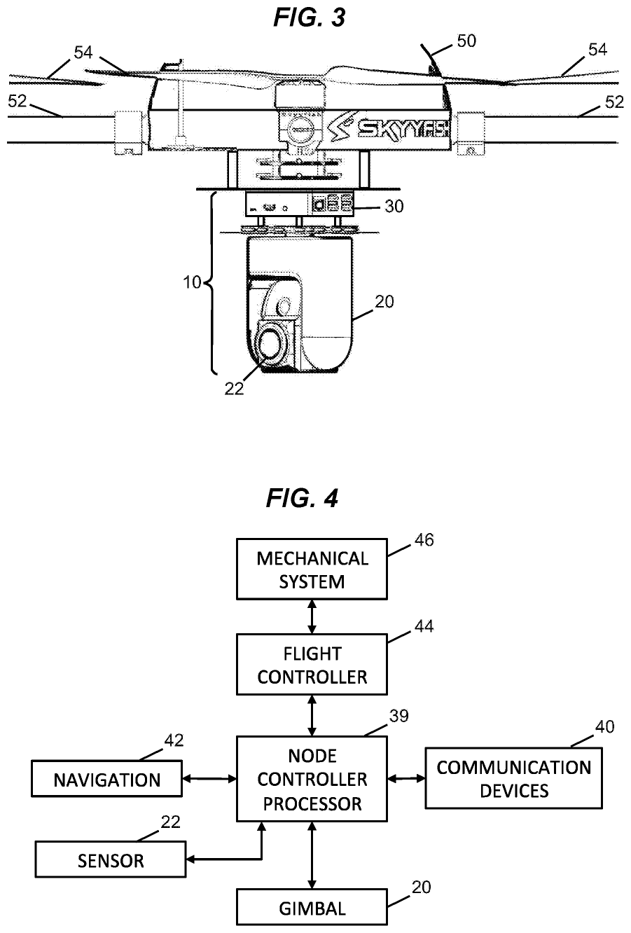

FIG. 3 shows a gimbal assembly 10, with its gimbal 20 and node controller 30, attached to the underside of a UAV 50. The UAV 50 is shown in part, including portions of its rotor arms 52 and rotor blades 54.

Referring to FIG. 4, the interrelation of the node controller processor 39, which is the core of the node controller 30, with the other functions and/or components of a UAV 50 is shown. The node controller processor 39 interacts with the gimbal 20, one or more sensors 22 and one or more communication devices 40. The node controller processor 39 also interacts with a navigation module 42, which is included in some embodiments of the node controller 30. The navigation module 42 has the capability of controlling the flight of the UAV 50 to which the node controller 30 is attached, by communications with the flight controller 44 of the UAV. In turn, the flight controller 44 communicates with and controls the mechanical system 46 of the UAV 50, which includes the motors of the UAV.

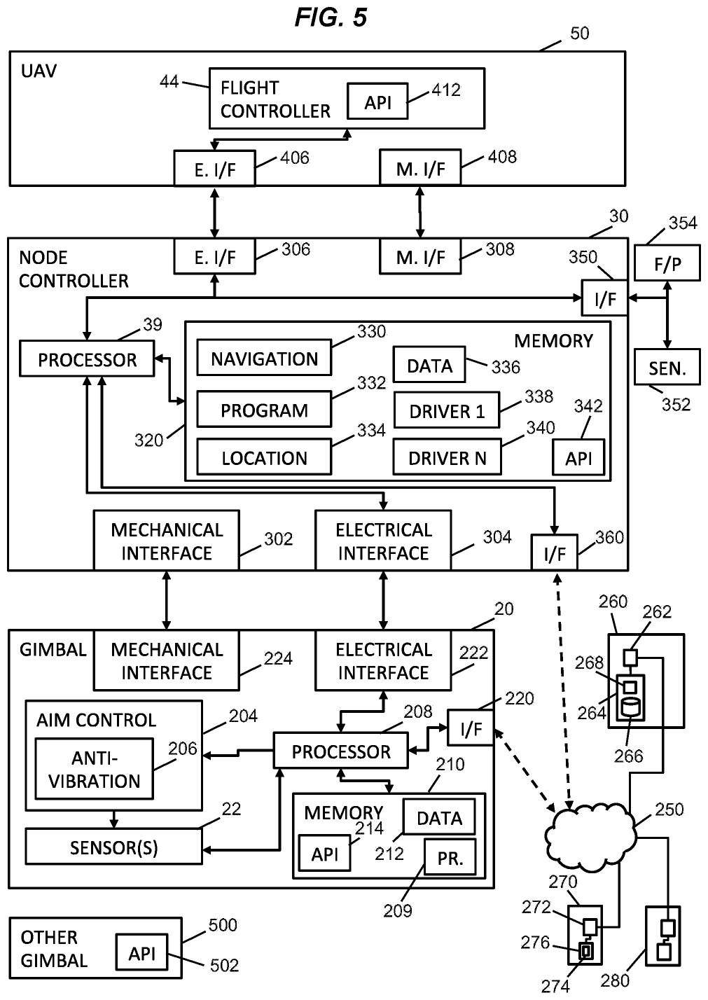

Referring to FIG. 5, a block diagram of the main modules of the gimbal assembly 10 and connected UAV 50 are shown.

Near the bottom, the gimbal 20 portion of the gimbal assembly includes one or more sensors 22. The sensor(s) 22 may be built-in or detachable from the gimbal 20, or they may be added external components. The sensor(s) are controlled by an aim control module 204, which may also include an anti-vibration module 206. The aim control module 204 controls electrical and/or mechanical components that adjust the direction in which the sensor(s) 22 are pointing. A processor 208 controls the aim control module 204 under the direction of a program 209 in a computer readable memory 210. The memory 210 may also store data 212 relating to the control of the sensor(s) 22 and other functions of the gimbal 20. The data 212 may also include data that is obtained from the sensor(s) 22 and stored in the memory 210.

The gimbal 20 also includes an API (application programming interface) 214 in its memory 210, via which commands can be received from the node controller 30 and interpreted to operate the sensor(s) 22 on the gimbal, the data collection from the sensors, and/or the transmission of that data from the gimbal via a wireless interface 220. The API 214 can be used for customizing the gimbal assembly 10 for different tasks, such as using machine learning algorithms for collision avoidance using attached or onboard sensors 22.

In other embodiments, the interface 220 may include a connector for a wired connection to an external device or network 250, or there may only be a connector for wired connections on the gimbal 20 if there is no need for a wireless connection to be made.

The gimbal 20 may interface via network 250 to a remote server 260, having a processor 262 and computer readable memory 264 that can store data 266 obtained from the sensor(s) 22 under the control of the processor 262. Memory 264 also stores computer readable instructions 268 for enabling access to the data 266 in the memory, and for application programs. Also connected to the network may be a remote-control unit 270, which may be a bespoke remote control, a smart phone, a laptop or other user computing device. The remote-control unit has a processor 272, which executes computer readable instructions 274 that are stored in a memory 276 of the remote-control unit in order to send control signals to the gimbal 20 in response to user inputs to the remote-control unit.

One or more further user computing devices 280 may also be connected to the network 250 and configured to communicate with the server 260, the remote-control unit 270, the gimbal assembly 10 and/or the UAV.

The gimbal 20 also includes an electrical interface 222 and mechanical interface 224, both for connecting the gimbal to the node controller 30.

The node controller 30 includes a processor 39, a mechanical interface 302 for connecting to the gimbal 30, an electrical interface 304 for connecting to the gimbal, an electrical interface 306 for connecting to the UAV, a mechanical interface 308 for connecting to the UAV and a computer readable memory 320 operably connected to the processor 39. The memory includes a navigation module 330, one or more programs 332, a location module 334, data 336, one or more drivers 338, 340 and an API 342. Also included are one or more further interface(s) 350 for connecting to further sensors 352 that may be mounted on the gimbal 20, the node controller 30 or the UAV 50. Also, a flight plan 354 may be input to the node controller 30 via a further interface 350. The flight plan 354 is stored in the memory 320, and may be stored within the navigation module 330. The further interfaces 350 may support wired connections, wireless connections or both.

The node controller 30 can directly connect to several cloud services by using the onboard computer's communication links, such as interface 360, and a web API of the cloud service.

The UAV 50 includes flight controller 44, electrical interface 406 for connection with the node controller 30 and mechanical interface 408 also for connecting to the node controller. The flight controller also has an API 412 via which instructions from the node controller can be interpreted and used to control the flight of the UAV 50.

The node controller 30 can be used to control other gimbals 500, as long as they have an external API 502.

### D. Other Configurations

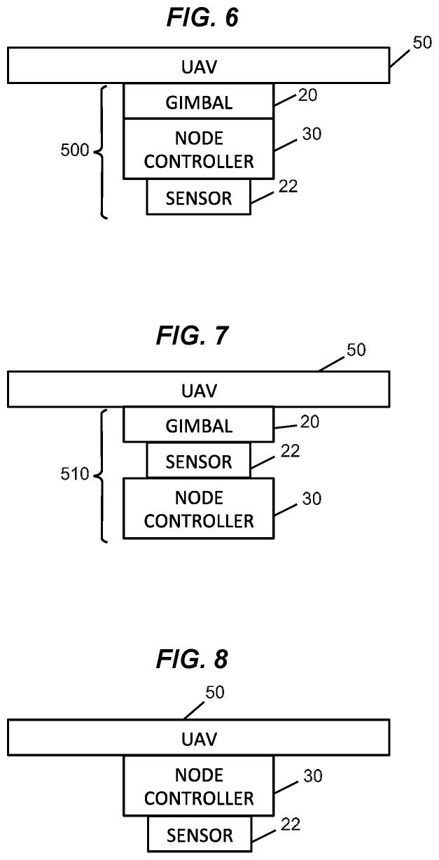

FIG. 6 shows a configuration 500 of the gimbal assembly in which the node controller 30 is adjacent to the sensor 22, and the gimbal 20 is connected directly or via an interface to the UAV 50. Here, the sensor 22 is mounted on the node controller 30. In this configuration 500 of the gimbal assembly, the electronic communication connections between the sensor 22 and the node controller 30 do not need to pass through the slip rings of the gimbal 20.

FIG. 7 shows a configuration 510 of the gimbal assembly, also in which the node controller 30 is adjacent to the sensor 22, and the gimbal 20 is connected directly or via an interface to the UAV 50. Here, the node controller 30 is mounted on the sensor 22. Again, in this configuration 510 of the gimbal assembly, the electronic communication connections between the sensor 22 and the node controller 30 do not need to pass through the slip rings of the gimbal 20. In other embodiments, the node controller 30 and the sensor 22 may both be mounted directly onto the gimbal 20, adjacent or close to each other, such that the electronic communication connections between the sensor 22 and the node controller 30 do not need to pass through the slip rings of the gimbal 20.

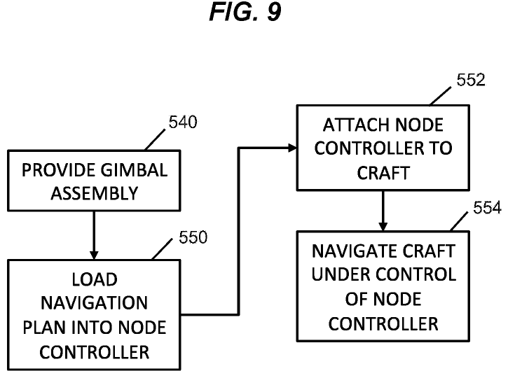

FIG. 8 shows a configuration of the gimbal assembly in which the gimbal 20 has been removed. The node controller 30 is mounted on the UAV 50 and the sensor 22 is mounted in a fixed position on the node controller. In other embodiments, the sensor is mounted on the UAV 50 and the node controller is mounted on the sensor 22, or both the sensor and node controller are mounted on the UAV without necessarily being next to each other. In this configuration the node controller 30 controls the sensor 22 depending on the position of the UAV 50, or controls both the UAV and the sensor. Even though the sensor 22 is in a fixed position on the UAV 50, it may have some built-in mechanism for limited control of its pointing direction, depending on the type of sensor. In this case, the node controller can control the aim of the sensor to the extent of its limitations.

### E. Operations

The gimbal assembly 10 can be used to navigate a UAV 50 in order to collect information from the sensors 22 that it is carrying. The node controller 30 controls the flight controller 44 based on the data collection needs of the gimbal 20 or on instructions in the program 332. The gimbal 20 can communicate with the UAV's flight controller 44 via the interfaces 306, 406 and command it, including one or more of commanding it to:

a. take off to a given altitude at a defined speed;

b. pause and continue, as necessary;

c. retract landing gear;

d. get GPS, speed, etc. on demand;

e. fly to a way point at a defined speed and altitude, and repeat as necessary;

f. rotate the craft (i.e. heading adjustment);

g. follow terrain;

h. use flight controller information to avoid collisions;

i. deploy landing gear; and

j. land at a given location at a defined speed.

The gimbal assembly 10 communicates with an external planning and navigation software application, for example software 268 on the server 260 or on a user computing device 280. The software is used for uploading data collection plans and parameters to the node controller 30 via interface 360.

The gimbal assembly 10 allows for more complex plans. For example, for tower inspection, the user might draw a circle or polygon around a tower on a map in planning mode. The user could specify that a special mode could be activated, such as a tower-inspection mode. The tower-inspection mode queries the user for structural information, such as the dimensions of the tower, equipment levels (height above ground), guy-wires, and more. The planning software automatically generates a new flight plan using the circle or polygon as a rough estimate of the tower's location. The software then creates, from the 2D, latitude and longitude map-based drawing a 3D plan that extends the flight plan in the altitude dimension. Since the gimbal assembly 10 can accommodate new sensors 22 easily, the tower inspection use-case can take advantage of dual radar cones that can sense edges and obstacles. In this case, a rough estimate of the tower location is all that is needed for a safe flight.

The flight plan may take into consideration outputs from 3D model building software (e.g. Bentley Systems™) that uses photographs and the exact location of the photographs to build a point cloud. The point clouds (3D models) require that photographs be taken with various requirements including, for example: overlap, different viewing angles (e.g. 45° above, oblique, 45° below), and cm-grade accuracy of camera using RTK GPS. The combination of output from model building software combined with the gimbal assembly 10 provides a unique combination for data-driven navigation. The requirements of the point-cloud model (resolution, area coverage, etc.) drive the flight path and sensor selection. Automatic or manual change detection of the point-cloud model over time (several different data collection items spanning days, months or years) can be used to modify flight paths. For example, several flights might reveal that a communication antenna mounting is deflecting due to wind force. In another example, UAV inspections can keep track on a communication tower of open space for rent at critical altitudes and angles.

If users do not feel comfortable using complete automation, they could fly the path the first time manually, then take the UAV 50 to critical points around the tower. The gimbal assembly 10 could query the users as they fly the UAV 50, asking them to provide a rough path at several different altitudes around the tower. For example, the software might ask the user to fly the UAV to approximately 10 feet below a guy-wire and 10 feet out from the tower. This in essence would be a control point. The UAV would automatically record the precise location and generate a safe path based on these points.

In yet another example, the user could set out remote devices, which use RTK GPS to precisely find their location, and report their location back to the UAV. In another case the user would set out 4 remote beacons at each comer to provide an onsite marker of the tower locations.

Each different UAV can be treated as a device that the gimbal assembly 10 uses as needed. Each specific UAV has an associated driver 338, 340, which is software that is loaded and installed in the memory 320 of the node controller 20 and allows the gimbal assembly 10 to control the UAV.

The gimbal assembly 10 is agnostic to the type of UAV 50 and its type of flight controller 44. The type of UAV 50 or any other craft that the gimbal assembly 10 is attached to does not matter. The gimbal assembly 10 can interact with any UAV 50 so long as the UAV as an external API 412. For example, an autonomous car could be used as the craft and controlled by the gimbal assembly 10.

The node controller 30 can enter a “sandbox” mode, which is an inverse of geo-fencing. Geofencing stops the UAV from entering restricted areas, where as sandboxing keeps the UAV in a safe area. An example of a safe area would be a cylindrical annulus around a tower that an inspector wants to examine.

In addition, the gimbal assembly 10 can still operate its own functions even if it cannot control the UAV 50 or other craft to which it is attached, provided that it can be mechanically attached to the UAV or other craft and that it has a power source or access to one from the UAV or other craft. For example, the gimbal assembly 10 can be set up to continuously record data. Alternately, to be more efficient, the planning software (e.g. program 332 in the node controller 20) is used to command the gimbal 20 to shut off when it is outside a region that is not of interest to the user, as determined by location module 334. The gimbal assembly 10 can therefore use geo-fencing technology to collect information efficiently.

The gimbal assembly 10 can also control several sensors 22, 352 based on location, as determined or obtained by location module 334, and other parameters collected from the UAV 50. The gimbal assembly 10 can be given a data collection plan (e.g. program 332) and using this it can control aiming of the sensor(s) 22, 352 based on (a) direct plan information and/or (b) UAV location and data collection parameters (e.g. collect data over a given area while calculating the flight path based on a desired sensor coverage).

The gimbal assembly 10 can also change the waypoints of the UAV's flight plan based on data collection requirements. For example, an area is defined and the gimbal assembly 10 calculates a flight path that allows the chosen sensor or sensors to cover the area.

The gimbal assembly 10 can also record sensor data (images, points, etc.) and meta-data (location, speed, etc.) either in the memory 212 of the gimbal 20 and/or in the memory 320 of the node controller 30.

Certain meta-data, such as gimbal angles that are provided via encoded motors in the gimbal 20, are used to significantly reduce the processing time when creating 3D models for photogrammetry.

The gimbal assembly 10 can also correct the data that is collected. For example, a program 332 in the node controller 30 can adjust the location of a picture acquired from an optical camera based on one or more of: a time delay in recording the picture based on the operating speed of the hardware; the speed of UAV 50; and the location of the UAV (e.g. altitude, latitude and longitude). These types of corrections can be made for any number of sensors 22. The gimbal assembly 10 has a solid-state drive (e.g. memory 320) for recording information (data 336) that is directly accessible via USB3, for example.

Each sensor 22, 352 (optical camera, thermal or forward looking infra-red (FLIR), Lidar, GPS, etc.) has a simple software driver 338, 340 loaded into the memory 320 of the node controller 20, allowing the gimbal assembly 10 to interface with the sensor. New drivers can be added as and when required in order to operate other sensors and/or gimbals. This configuration of gimbal assembly 10 in a module separate from the node controller 20 facilitates plug-and-play operation. This means that different types/configurations of gimbals, sensors, and UAVs, can be coupled together and achieve a quick turnaround and seamless operation for a desired mission. This plug-and-play feature for the stack of components for an unmanned vehicle allows for modular, extensible, and flexible operation. For instance, the electro-mechanical interfaces of every component (i.e. software API/mechanical) is well defined, coupled with their quick release mechanisms, are capable of being placed in various configurations, i.e. flexible, resulting in smart components with configurations that can be changed in the field by a user or even changed robotically by a ground station.

The interface (e.g. interface 350), which may include multiple connectors, interfaces or transceivers, allows one or more of: raw data transfer; triggering of data collection (start, pause, stop, record, etc.); and sensor parameter adjustment. The interface 350 can be, or can include, one or more quick-release mechanisms for several different types of sensor 352. Likewise, the mechanical interface 302 and electrical interface 304 can also be, or include, quick-release mechanisms for multiple different types of gimbal 20.

Upon landing the UAV 50, the collected data 336 can be streamed directly to a server 260, for example. The server can optionally ortho-normalize, stitch, and tile the data, or analyze it to create intelligence reports.

Since the gimbal assembly 10 (or smart gimbal) has access to all UAV data, sensor data, and UAV control functions, it can be used to successfully create a safe, autonomous navigation system. With the addition of the extra processing power in the node controller 30, the gimbal assembly 10 can adjust speed and heading of the UAV 50 to avoid obstacles. In addition, the node controller 30 can learn to recognize safe paths, recognize danger, recognize humans (non-participants) and calculate safe trajectories.

As mentioned above the gimbal assembly 10 can calculate flight path based on data collection needs, specifically model building; collision avoidance; previous safe flights; and multiple sensor needs, for example thermal sensors might require a different overlap than optical sensors.

Referring to FIG. 9, a flowchart is shown of a method involving the gimbal assembly 10. In step 540, a gimbal assembly 10 is provided, the assembly comprising a gimbal 20, a sensor 22 and a node controller 30. In step 550, a navigation plan or portion of a navigation plan is loaded into the memory 320 of the node controller 30. In step 552 the node controller 30, and hence the gimbal assembly 10, is attached to the craft, e.g. UAV 50, if it is not already attached. In step 554, the craft is navigated, either under complete or partial control of the node controller 30. Here, navigation refers both to controlling the path of flying craft as well as non-flying craft.

Although the present invention has been illustrated principally in relation to UAVs it also has wide application in respect of other crafts and autonomous vehicles such as rovers.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware, firmware and software is not always sharp, it being understood by those skilled in the art that the software implemented processes and modules described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid-state memories, etc. The methods may alternatively be embodied partly or wholly in specialized computer hardware, such as ASIC or FPGA circuitry.

It will be clear to one having skill in the art that variations to the specific details disclosed herein can be made, resulting in other embodiments that are within the scope of the invention disclosed. Steps in the flowchart may be performed in a different order, other steps may be added, or one or more steps may be removed without altering the main function of the system. All parameters, quantities, and configurations described herein are examples only and actual values of such depend on the specific embodiment. Modules may be combined, duplicated or divided into constituent parts, some modules may be omitted and others added. Modules may be used in different positions and different relative positions to each other. The core function of the intelligent gimbal assembly is that its node controller controls at least one of the gimbals, the sensor and the UAV, at least in part. Accordingly, the scope of the invention is to be construed in accordance with the substance defined by the eventual claims.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

What is claimed is:

1. An assembly for controlling an unmanned vehicle comprising:
a first gimbal having a gimbal mechanical interface, a gimbal electrical interface and a gimbal communication interface;
a node controller external to the first gimbal and communicatively coupled to the first gimbal via said gimbal communication interface, said node controller having:
a processor,
a first electrical interface connection to the first gimbal via the gimbal electrical interface,
a second electrical interface for connecting to an unmanned vehicle,
a first mechanical interface connection to the first gimbal via the gimbal mechanical interface,
a second mechanical interface for connecting to the unmanned vehicle,
a sensor interface with one or more quick-release mechanisms for several different types of sensors, and
a computer readable memory operably connected to the processor, wherein the computer readable memory comprises a plurality of software drivers,
wherein said plurality of software drivers comprises one or more software drivers for each one of the different types of sensors, said sensors having configurable electro-mechanical interfaces, wherein the computer readable memory comprises an application program interface (“API”) for connecting to one or more other sensors and one or more other gimbals; and
a first sensor coupled to said first gimbal via said sensor interface;
wherein the node controller is configured to be removably coupled to the unmanned vehicle via said second mechanical interface.

2. The assembly of claim 1, wherein the node controller is configured to control the first gimbal.

3. The assembly of claim 2, wherein the node controller is detachable from the first gimbal and configured to attach to and control a further, different type of gimbal.

4. The assembly of claim 1, wherein the node controller is configured to control the first sensor.

5. The assembly of claim 1, wherein the first sensor is mounted directly onto the first gimbal.

6. The assembly of claim 1, wherein the unmanned vehicle is an unmanned aerial vehicle (UAV) and the node controller is configured to control a flight controller in the UAV.

7. The assembly of claim 6, wherein the node controller is detachable from the first gimbal and configured to attach to and control a further, different type of UAV.

8. The assembly of claim 7, wherein the node controller is configured to control a further sensor that is fixed to the further UAV without a gimbal.

9. The assembly of claim 6, wherein the node controller comprises a software driver for each of multiple different types of UAV.

10. The assembly of claim 6, wherein the node controller comprises an interface for receiving a flight plan.

11. The assembly of claim 10, wherein the node controller is configured to communicate with a software application external to the node controller that provides the flight plan to the node controller.

12. The assembly of claim 1, wherein the node controller is mechanically connected directly to the first gimbal.

13. The assembly of claim 1, wherein the node controller and the first sensor are both mounted on the first gimbal and wired electrical connections between the node controller and the first sensor do not pass through slip rings of the first gimbal.

14. The assembly of claim 1, wherein the first gimbal is mounted onto the node controller and the node controller is configured to mechanically connect to the unmanned vehicle.

15. The assembly of claim 1, further comprising an interface via which the first gimbal is mechanically connected to the node controller, wherein the interface has one or more electrical connectors for electrically connecting the first gimbal to the node controller.

16. The assembly of claim 1, wherein the first sensor is a camera, a video camera, an infra-red camera, a Lidar sensor, an infra-red detector or a global positioning device.

17. The assembly of claim 1, wherein the node controller comprises one or more electrical connectors for connection to the unmanned vehicle.

18. The assembly of claim 1, further comprising a base from which the node controller is suspended, the base having one or more mechanical connectors configured to connect the node controller to the unmanned vehicle.

19. The assembly of claim 1, wherein each of the one or more other gimbals includes an API.

20. An assembly for controlling an unmanned vehicle comprising:
a first gimbal having a gimbal mechanical interface, a gimbal electrical interface and a gimbal communication interface;
a node controller coupled to the first gimbal, said node controller having a processor, a first electrical interface connection to the first gimbal via the gimbal electrical interface, a second electrical interface for connecting to an unmanned vehicle, a first mechanical interface connection to the first gimbal via the gimbal mechanical interface, a second mechanical interface for removably connecting to the unmanned vehicle, wherein the first mechanical interface and first electrical interface comprises quick-release mechanisms for multiple different types of gimbals;
said node controller further comprising a sensor interface with one or more quick-release mechanisms for several different types of sensors; and
said node controller further comprising a computer readable memory operably connected to the processor, wherein the computer readable memory comprises a plurality of software drivers with one or more software drivers for each one of the different types of sensors, each of said different types of sensors having configurable electro-mechanical interfaces, wherein the computer readable memory comprises an application program interface (“API”) for connecting to one or more other sensors and one or more other gimbals.
